(19) United States
(12) Patent Application Publication
(10) Pub. No.: US 2026/0074236 A1
(43) Pub. Date: Mar. 12, 2026

(54) LAMINATE, METHOD OF MANUFACTURING THE LAMINATE AND ELECTRODE

(71) Applicant: SK On Co., Ltd., Seoul (KR)

(72) Inventors: Chang Mook HWANG, Daejeon (KR); Hyun Ji KIM, Daejeon (KR); Jong Hyeok LEE, Daejeon (KR); Yoon Ji JO, Daejeon (KR)

(21) Appl. No.: 19/325,961

(22) Filed: Sep. 11, 2025

(30) Foreign Application Priority Data
Sep. 11, 2024 (KR) 10-2024-0124140
Sep. 10, 2025 (KR) 10-2025-0129421

(51) Int. Cl. H01M 4/66; H01M 4/04

(52) U.S. Cl. CPC H01M 4/667; H01M 4/0407; H01M 4/661; H01M 4/668

(57) ABSTRACT

The present disclosure relates to a laminate, method of manufacturing the laminate and electrode according to one embodiment comprises: a metal film and a primer layer on at least one surface of the metal film, wherein the primer layer comprises a copolymer, and the copolymer may comprise a first unit containing an aromatic group, a second unit being an alkylene group, and a third unit being an alkylene group different from the second unit.

### CROSS-REFERENCE TO RELATED PATENT APPLICATION

The present application claims priority under 35 U.S.C. § 119(a) to Korean patent application number 10-2024-0124140 filed on Sep. 11, 2024 and Korean patent application number 10-2025-0129421 filed on Sep. 10, 2025 in the Korean Intellectual Property Office, the entire disclosure of which is incorporated by reference herein.

### BACKGROUND OF THE INVENTION

### 1. Field

The present disclosure relates to a laminate and a method for manufacturing the laminate. In addition, the present disclosure relates to an electrode including the laminate and a battery including the electrode. In addition, the present disclosure relates to a method for manufacturing the electrode and the battery.

### 2. Description of the Related Art

Recently, the demand for mobile devices such as smartphones, tablet PCs, and wireless earphones has been increasing. In addition, as the development of electric vehicles, energy storage batteries, robots, and satellites is being accelerated, research on high-performance secondary batteries capable of repeated charging and discharging as an energy source is actively being conducted.

Currently, commercially available secondary batteries include nickel-cadmium batteries, nickel-hydrogen batteries, nickel-zinc batteries, and lithium secondary batteries. Among them, the lithium secondary battery is attracting attention due to advantages such as almost no memory effect compared to nickel-based secondary batteries, freedom of charging and discharging, very low self-discharge rate, and high energy density.

Meanwhile, as methods for manufacturing a current collector, a rolling method and an electroplating method are widely known. The rolling method is a method of manufacturing the current collector in the form of a thin film sheet by applying a physical force. The electroplating method is a method of manufacturing the current collector by allowing a drum serving as a negative electrode to contact an electrolyte solution and peeling off a metal thin film sheet deposited on the drum. In particular, the electroplating method is mainly adopted because it can secure excellent productivity while exhibiting favorable physical properties. Patent Documents 1 and 2 disclose methods for manufacturing the current collector through the electroplating method.

### PRIOR ART DOCUMENT

(Patent Document 1) Korean published patent No. 10-2014-0023955 (Title: LITHIUM ION SECONDARY CELL, CURRENT COLLECTOR CONSTITUTING NEGATIVE ELECTRODE OF SECONDARY CELL, AND ELECTROLYTIC COPPER FOIL CONSTITUTING NEGATIVE-ELECTRODE CURRENT COLLECTOR)
(Patent Document 2) Korean granted patent No. 10-2037846 (Title: METHOD FOR MANUFACTURING ELECTROLYTIC ALUMINUM FOIL)

### SUMMARY OF THE INVENTION

The present disclosure can provide a laminate and a method for manufacturing the laminate, which minimize problems in which an inner surface and an outer surface are respectively deteriorated by stress due to compression and stress due to elongation during bending. In addition, the present disclosure can provide a laminate and a method for manufacturing the laminate, which can prevent crack occurrence on a surface and lithium precipitation phenomenon caused by stress acting during bending. In addition, the present disclosure can provide a metal film and a method for manufacturing the metal film, which improve a problem in which electrode density of an inner surface and an outer surface becomes different. In addition, the present disclosure can provide a laminate and a method for manufacturing the laminate, which can prevent reduction of battery lifespan. In addition, the present disclosure can provide a laminate and a method for manufacturing the laminate, which improve a problem of resistance increase occurring as elongation by bending is made. In addition, the present disclosure can provide an electrode including the laminate and a battery including the electrode, and can provide a method for manufacturing the electrode and the battery.

The laminate and the method for manufacturing the laminate according to one aspect of the present disclosure can be widely applied to green technology fields such as electric vehicles, battery charging stations, and solar power generation and wind power generation using batteries. In addition, the laminate and the method for manufacturing the laminate according to one aspect of the present disclosure can be applied to battery manufacturing processes used in eco-friendly electric vehicles or hybrid vehicles for preventing climate change by suppressing air pollution and greenhouse gas emissions.

One aspect of a laminate according to the present disclosure may comprise a metal film and a primer layer on at least one surface of the metal film, wherein the primer layer comprises a copolymer, and the copolymer may comprise a first unit containing an aromatic group, a second unit being an alkylene group, and a third unit being an alkylene group different from the second unit.

In one embodiment, a ratio (N_{C2}/N_{C3}) of the number of carbon atoms (N_{C2}) of a main chain of the second unit to the number of carbon atoms (N_{C3}) of a main chain of the third unit may be 0.1 or more and 1 or less.

In one embodiment, the aromatic group of the first unit may be an aryl group.

In one embodiment, the copolymer may be a thermoplastic elastomer having a weight average molecular weight (Mw) of 10,000 to 30,000 g/mol and a polydispersity index (PDI) of 1 to 2.

In one embodiment, the primer layer may comprise the copolymer in a range of 50 to 70% by weight based on a total weight.

In one embodiment, the metal film may comprise one or more uneven portions on a surface thereof, and the primer layer may be formed to surround the one or more uneven portions.

In one embodiment, a surface of the primer layer may have a pattern in which protrusions and recesses are repeated.

In one embodiment, the primer layer may further comprise a conductive material.

In one embodiment, the conductive material may comprise carbon nanotubes (CNT).

In one embodiment, the metal film may comprise a first surface and a second surface opposite to the first surface, and the first surface may have greater roughness than the second surface.

In one embodiment, the metal film may comprise at least one selected from the group consisting of chlorine and iodine.

In one embodiment, the metal film may comprise chlorine, and the chlorine may be comprised in a range of 1% by weight to 30% by weight based on a total weight.

In one embodiment, the metal film may comprise iodine, and the iodine may be comprised in a range of 0.001% by weight to 0.1% by weight based on a total weight.

In one embodiment, crystal grains may be formed on the first surface and the second surface.

In one embodiment, the metal film may comprise copper or aluminum.

One aspect of a method for manufacturing a laminate according to the present disclosure may comprise forming a primer layer on at least one surface of a metal film, wherein the primer layer comprises a copolymer, and the copolymer comprises a first unit containing an aromatic group, a second unit being an alkylene group, and a third unit being an alkylene group different from the second unit.

In one embodiment, the method may comprise manufacturing the metal film before forming the primer layer, wherein the step of manufacturing the metal film comprises manufacturing the metal film by bringing at least a portion of a metal sheet including a first surface and a second surface opposite to the first surface into contact with a first electrolyte solution containing metal ions, wherein the first surface of the metal sheet reacts with the first electrolyte solution, and wherein the second surface of the metal sheet may substantially not react with the first electrolyte solution.

One aspect of the present disclosure can provide an electrode comprising the above-described laminate and an active material layer formed on at least one surface of an outermost portion of the laminate.

One aspect of the present disclosure can provide a battery comprising an electrode and a separator, wherein the electrode comprises the electrode according to an embodiment of the present disclosure.

The present disclosure can provide a laminate and a method for manufacturing the laminate, which minimize problems in which an inner surface and an outer surface are respectively deteriorated by stress due to compression and stress due to elongation during bending. In addition, the present disclosure can provide a laminate and a method for manufacturing the laminate, which can prevent crack occurrence on a surface and lithium precipitation phenomenon caused by stress acting during bending. In addition, the present disclosure can provide a metal film and a method for manufacturing the metal film, which improve a problem in which electrode density of an inner surface and an outer surface becomes different. In addition, the present disclosure can provide a laminate and a method for manufacturing the laminate, which can prevent reduction of battery lifespan. In addition, the present disclosure can provide a laminate and a method for manufacturing the laminate, which improve a problem of resistance increase occurring as elongation by bending is made. In addition, the present disclosure can provide an electrode including the laminate and a battery including the electrode, and can provide a method for manufacturing the electrode and the battery.

### BRIEF DESCRIPTION OF THE DRAWINGS

FIG. 1 is a view briefly illustrating at least a part of a structure of a jelly roll.

FIG. 2 is a view briefly illustrating at least a part of a structure of a negative electrode.

FIG. 3 is a view exemplarily showing at least a part of a metal film according to one example of the present disclosure.

FIG. 4 is a view briefly illustrating a manufacturing process of a metal film according to one example of the present disclosure.

FIGS. 5 and 6 are views exemplarily showing at least a part of a laminate according to one example of the present disclosure.

### DETAILED DESCRIPTION

In the present disclosure, among the physical properties mentioned, in cases where a measurement temperature affects the physical property, unless otherwise specifically defined, the physical property is a property measured at room temperature.

The term “room temperature” used in the present disclosure means a natural temperature that is not heated or cooled, and may refer, for example, to any one temperature in a range of 10° C. to 30° C., such as about 15° C. or more, about 18° C. or more, about 20° C. or more, about 23° C. or more, about 27° C. or less, or 25° C. Unless otherwise specifically defined in the present disclosure, the unit of temperature is Celsius (° C.).

In the present disclosure, among the physical properties mentioned, in cases where a measurement pressure affects the physical property, unless otherwise specifically defined, the physical property is a property measured at atmospheric pressure.

The term “atmospheric pressure” used in the present disclosure means a natural pressure that is not pressurized or depressurized, and ordinarily refers to an atmospheric pressure in a range of about 700 mmHg to 800 mmHg.

The term “a to b” used in the present disclosure means a range including a and b and between a and b. For example, “comprising a to b parts by weight” has the same meaning as comprising in the range of a to b parts by weight.

The term “film” used in the present disclosure means a sheet having a thickness of about 1 mm or less. In addition, the film is not particularly limited in shape as long as it satisfies the above thickness range. The film may also be referred to as a foil.

The term “substitution” used in the present disclosure means that a hydrogen atom bonded to a carbon atom of a compound is replaced with another substituent, and the position to be substituted is not particularly limited as long as it is a position where the hydrogen atom can be substituted, i.e., a position where the substituent can be introduced. In cases where two or more substitutions occur, the substituents may be the same as or different from each other.

The term “substituent” used in the present disclosure means an atom or a group of atoms that replaces one or more hydrogen atoms on a parent chain of a hydrocarbon. In addition, the substituent is not limited to those described below, and unless otherwise specifically described in the present disclosure, the substituent may be further substituted with the substituents described below or may remain unsubstituted.

The term “alkyl group” or “alkylene group” used in the present disclosure, unless otherwise specified, may be a straight-chain or branched-chain alkyl group or alkylene group having 1 to 20 carbon atoms, or having 1 to 16 carbon atoms, or having 1 to 12 carbon atoms, or having 1 to 8 carbon atoms, or having 1 to 6 carbon atoms, or may be a cyclic alkyl group or alkylene group having 3 to 20 carbon atoms, or having 3 to 16 carbon atoms, or having 3 to 12 carbon atoms, or having 3 to 8 carbon atoms, or having 3 to 6 carbon atoms. Here, the cyclic alkyl group or alkylene group includes not only an alkyl group or alkylene group existing solely in a ring structure but also an alkyl group or alkylene group including a ring structure within its structure. For example, cyclohexyl group and methylcyclohexyl group both correspond to cyclic alkyl groups. Further, for example, the alkyl group or alkylene group may specifically include, but is not limited to, methyl(ene), ethyl(ene), n-propyl(ene), isopropyl(ene), n-butyl(ene), isobutyl(ene), tert-butyl(ene), sec-butyl(ene), 1-methyl-butyl(ene), 1-ethyl-butyl(ene), n-pentyl(ene), isopentyl(ene), neopentyl(ene), tert-pentyl(ene), n-hexyl(ene), 1-methylpentyl(ene), 2-methylpentyl(ene), 4-methyl-2-pentyl(ene), 3,3-dimethylbutyl(ene), 2-ethylbutyl(ene), n-heptyl(ene), 1-methylhexyl(ene), n-octyl(ene), tert-octyl(ene), 1-methylheptyl(ene), 2-ethylhexyl(ene), 2-propylpentyl(ene), n-nonyl(ene), 2,2-dimethylheptyl(ene), 1-ethylpropyl(ene), 1,1-dimethylpropyl(ene), isohexyl(ene), 2-methylpentyl(ene), 4-methylhexyl(ene), and 5-methylhexyl(ene). In addition, the cycloalkyl group or cycloalkylene group may specifically include, but is not limited to, cyclopropyl(ene), cyclobutyl(ene), cyclopentyl(ene), 3-methylcyclopentyl(ene), 2,3-dimethylcyclopentyl(ene), cyclohexyl(ene), 3-methylcyclohexyl(ene), 4-methylcyclohexyl(ene), 2,3-dimethylcyclohexyl(ene), 3,4,5-trimethylcyclohexyl(ene), 4-tert-butylcyclohexyl(ene), cycloheptyl(ene), and cyclooctyl(ene).

The term “alkenyl group” or “alkenylene group” used in the present disclosure, unless otherwise specified, may be a non-cyclic alkenyl group or alkenylene group of a straight chain or a branched chain having 2 to 20 carbon atoms, or having 2 to 16 carbon atoms, or having 2 to 12 carbon atoms, or having 2 to 8 carbon atoms, or having 2 to 6 carbon atoms; or may be a cyclic alkenyl group or alkenylene group having 3 to 20 carbon atoms, or having 3 to 16 carbon atoms, or having 3 to 12 carbon atoms, or having 3 to 8 carbon atoms, or having 3 to 6 carbon atoms. Here, if the alkenyl group or alkenylene group includes a ring structure, it corresponds to a cyclic alkenyl group or alkenylene group. For example, the alkenyl group or alkenylene group may specifically include, but is not limited to, ethenyl(ene), n-propenyl(ene), isopropenyl(ene), n-butenyl(ene), isobutenyl(ene), tert-butenyl(ene), sec-butenyl(ene), 1-methyl-butenyl(ene), 1-ethyl-butenyl(ene), n-pentenyl(ene), isopentenyl(ene), neopentenyl(ene), tert-pentenyl(ene), n-hexenyl(ene), 1-methylpentenyl(ene), 2-methylpentenyl(ene), 4-methyl-2-pentenyl(ene), 3,3-dimethylbutenyl(ene), 2-ethylbutenyl(ene), n-heptenyl(ene), 1-methylhexenyl(ene), n-octenyl(ene), tert-octenyl(ene), 1-methylheptenyl(ene), 2-ethylhexenyl(ene), 2-propylpentenyl(ene), n-nonenyl(ene), 2,2-dimethylheptenyl(ene), 1-ethylpropenyl(ene), 1,1-dimethylpropenyl(ene), isohexenyl(ene), 2-methylpentenyl(ene), 4-methylhexenyl(ene), and 5-methylhexenyl(ene). In addition, the cycloalkenyl group or cycloalkenylene group may specifically include, but is not limited to, cyclopropenyl(ene), cyclobutenyl(ene), cyclopentenyl(ene), 3-methylcyclopentenyl(ene), 2,3-dimethylcyclopentenyl(ene), cyclohexenyl(ene), 3-methylcyclohexenyl(ene), 4-methylcyclohexenyl(ene), 2,3-dimethylcyclohexenyl(ene), 3,4,5-trimethylcyclohexenyl(ene), 4-tert-butylcyclohexenyl(ene), cycloheptenyl(ene), and cyclooctenyl(ene).

The term “alkynyl group” or “alkynylene group” used in the present disclosure, unless otherwise specified, may be a non-cyclic alkynyl group or alkynylene group of a straight chain or a branched chain having 2 to 20 carbon atoms, or having 2 to 16 carbon atoms, or having 2 to 12 carbon atoms, or having 2 to 8 carbon atoms, or having 2 to 6 carbon atoms; or may be a cyclic alkynyl group or alkynylene group having 3 to 20 carbon atoms, or having 3 to 16 carbon atoms, or having 3 to 12 carbon atoms, or having 3 to 8 carbon atoms, or having 3 to 6 carbon atoms. Here, if the alkynyl group or alkynylene group includes a ring structure, it corresponds to a cyclic alkynyl group or alkynylene group. For example, the alkynyl group or alkynylene group may specifically include, but is not limited to, ethynyl(ene), n-propynyl(ene), isopropynyl(ene), n-butynyl(ene), isobutynyl(ene), tert-butynyl(ene), sec-butynyl(ene), 1-methyl-butynyl(ene), 1-ethyl-butynyl(ene), n-pentynyl(ene), isopentynyl(ene), neopentynyl(ene), tert-pentynyl(ene), n-hexynyl(ene), 1-methylpentynyl(ene), 2-methylpentynyl(ene), 4-methyl-2-pentynyl(ene), 3,3-dimethylbutynyl(ene), 2-ethylbutynyl(ene), n-heptynyl(ene), 1-methylhexynyl(ene), n-octynyl(ene), tert-octynyl(ene), 1-methylheptynyl(ene), 2-ethylhexynyl(ene), 2-propylpentynyl(ene), n-nonynyl(ene), 2,2-dimethylheptynyl(ene), 1-ethylpropynyl(ene), 1,1-dimethylpropynyl(ene), isohexynyl(ene), 2-methylpentynyl(ene), 4-methylhexynyl(ene), and 5-methylhexynyl(ene). In addition, the cycloalkynyl group or cycloalkynylene group may specifically include, but is not limited to, cyclopropynyl(ene), cyclobutynyl(ene), cyclopentynyl(ene), 3-methylcyclopentynyl(ene), 2,3-dimethylcyclopentynyl(ene), cyclohexynyl(ene), 3-methylcyclohexynyl(ene), 4-methylcyclohexynyl(ene), 2,3-dimethylcyclohexynyl(ene), 3,4,5-trimethylcyclohexynyl(ene), 4-tert-butylcyclohexynyl(ene), cycloheptynyl(ene), andcyclooctynyl(ene).

The alkyl group, alkylene group, alkenyl group, alkenylene group, alkynyl group, and alkynylene group may each independently be optionally substituted with one or more substituents, or may be unsubstituted and remain as hydrogen (H). The substituent may be at least one selected from the group consisting of a halogen element, an aryl group, a heteroaryl group, an epoxy group, an alkoxy group, a cyano group, a carboxyl group, an acryloyl group, a methacryloyl group, an acryloyloxy group, a methacryloyloxy group, a carbonyl group, and a hydroxy group, but is not limited thereto.

In addition, in the present disclosure, unless otherwise specified, the number of carbon atoms of the alkyl group, alkylene group, alkenyl group, alkenylene group, alkynyl group, and alkynylene group refers to the number of carbon atoms of a structure corresponding to a main chain, excluding the number of carbon atoms contained in substituents.

The term “aromatic group” used in the present disclosure can encompass both aryl groups and heteroaryl groups.

The term “aryl group” used in the present disclosure means an aromatic ring in which one hydrogen is removed from an aromatic hydrocarbon ring, and the aromatic hydrocarbon ring may include a monocyclic or polycyclic ring. The aryl group is not particularly limited in the number of carbon atoms but, unless otherwise specified, may be an aryl group having 6 to 30 carbon atoms, or 6 to 26 carbon atoms, or 6 to 22 carbon atoms, or 6 to 20 carbon atoms, or 6 to 18 carbon atoms, or 6 to 15 carbon atoms. In addition, the term “arylene group” used in the present disclosure means an aryl group having two bonding sites, that is, a divalent group. Except that each is divalent, the above description of the aryl group may apply. The aryl group may include, for example, phenyl group, phenylethyl group, phenylpropyl group, benzyl group, tolyl group, xylyl group, or naphthyl group, but is not limited thereto.

The term “heteroaryl group” used in the present disclosure means an aromatic ring including one or more heteroatoms other than carbon, and specifically, the heteroatom may include one or more atoms selected from the group consisting of nitrogen (N), oxygen (O), sulfur (S), selenium (Se), and tellurium (Te). In this case, atoms constituting the ring structure of the heteroaryl group may be referred to as ring atoms. The heteroaryl group may include a monocyclic ring or a polycyclic ring. The heteroaryl group is not particularly limited in the number of carbon atoms but, unless otherwise specified, may be a heteroaryl group having 2 to 30 carbon atoms, or 2 to 26 carbon atoms, or 2 to 22 carbon atoms, or 2 to 20 carbon atoms, or 2 to 18 carbon atoms, or 2 to 15 carbon atoms. In another example, the heteroaryl group is not particularly limited in the number of ring atoms but may be a heteroaryl group having 5 to 30 ring atoms, 5 to 25 ring atoms, 5 to 20 ring atoms, 5 to 15 ring atoms, 5 to 10 ring atoms, or 5 to 8 ring atoms. The heteroaryl group may include, for example, thiophenyl group, furanyl group, pyrrolyl group, imidazolyl group, thiazolyl group, oxazolyl group, oxadiazolyl group, triazolyl group, pyridyl group, bipyridyl group, pyrimidyl group, triazinyl group, acridyl group, pyridazinyl group, pyrazinyl group, quinolinyl group, quinazolinyl group, quinoxalinyl group, phthalazinyl group, pyridopyrimidyl group, pyridopyrazinyl group, pyrazinopyrazinyl group, isoquinolinyl group, indolyl group, carbazolyl group, benzoxazolyl group, benzimidazolyl group, benzothiazolyl group, benzocarbazolyl group, dibenzocarbazolyl group, benzothiophenyl group, dibenzothiophenyl group, benzofuranyl group, dibenzofuranyl group, benzosilolyl group, dibenzosilolyl group, phenanthrolinyl group, isoxazolyl group, thiadiazolyl group, phenothiazinyl group, phenoxazinyl group, and their fused structures, but are not limited thereto.

In addition, the term “heteroarylene group” used in the present disclosure means a heteroaryl group having two bonding sites, that is, a divalent group. Except that each is divalent, the above description of the heteroaryl group may apply.

The aryl group and the heteroaryl group may each independently be optionally substituted with one or more substituents, or may be unsubstituted and remain as hydrogen (H). The substituent may be at least one selected from the group consisting of a halogen element, an aryl group, a heteroaryl group, an epoxy group, an alkoxy group, a cyano group, a carboxyl group, an acryloyl group, a methacryloyl group, an acryloyloxy group, a methacryloyloxy group, a carbonyl group, and a hydroxy group, but is not limited thereto.

In addition, in the present disclosure, unless otherwise specified, the number of carbon atoms of the aryl group and the heteroaryl group refers to the number of carbon atoms of a structure corresponding to a main chain, excluding the number of carbon atoms contained in substituents. In addition, unless otherwise specified, the number of ring atoms of the heteroaryl group refers to the number of ring atoms of a structure corresponding to a main chain, excluding the number of ring atoms contained in substituents.

A lithium secondary battery generally comprises a positive electrode including a positive electrode active material, a negative electrode including a negative electrode active material, a separator for enabling movement of lithium ions between the positive electrode and the negative electrode and preventing a short, and an electrolyte for enabling movement of lithium ions. Here, the positive electrode and the negative electrode are collectively defined as an electrode. In addition, a structure including the positive electrode, the negative electrode, and the separator is defined as an electrode assembly.

The lithium secondary battery mainly uses a lithium-based oxide as a positive electrode active material and a carbon material as a negative electrode active material. In addition, the positive electrode and the negative electrode may be manufactured by coating an electrode slurry including the positive electrode active material or the negative electrode active material on a current collector in the form of a metal plate and then drying it.

In addition, the lithium secondary battery is classified into a lithium-ion battery using a liquid electrolyte and a lithium polymer battery using a polymer electrolyte, according to the type of electrolyte. In addition, the lithium secondary battery can be largely classified into cylindrical, prismatic, and pouch types.

Meanwhile, the electrode assembly can be classified into: a winding-type electrode assembly having a structure in which a separator is positioned between a positive electrode and a negative electrode in the form of sheets and wound; a stacking-type electrode assembly in which a separator is positioned between a positive electrode and a negative electrode cut into predetermined units and sequentially stacked; and a stack/folding-type electrode assembly having a structure in which bicells or full cells, in which a separator is positioned between predetermined units of a positive electrode and a negative electrode, are stacked and folded in one direction or in a zigzag direction using a long continuous separator sheet.

Such an electrode assembly is similar in shape to winding jelly, and is generally referred to as a jelly roll.

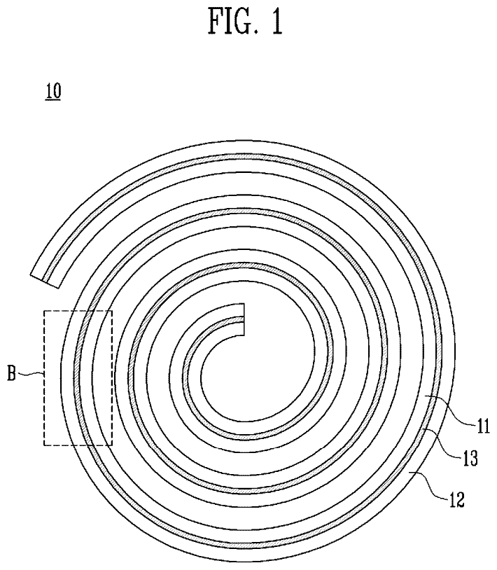

FIG. 1 is a view briefly illustrating at least a part of a structure of a jelly roll. That is, it is a view briefly illustrating the electrode assembly 10 in a jelly roll form. Referring to FIG. 1, it can be seen that a jelly roll form is formed by sequentially stacking a positive electrode 11, a separator 13, and a negative electrode 12, and then winding them.

The electrode assembly 10 in a jelly roll form, which is obtained by sequentially providing the positive electrode 11, the separator 13, and the negative electrode 12 in the form of sheets and winding them, inevitably has a bent portion. For example, the bent portion may mean portion B in FIG. 1.

The bent portion includes an inner surface Iₛ where stress due to compression acts and an outer surface Iₒ where stress due to extension acts. The inner surface and the outer surface are respectively deteriorated due to different mechanisms.

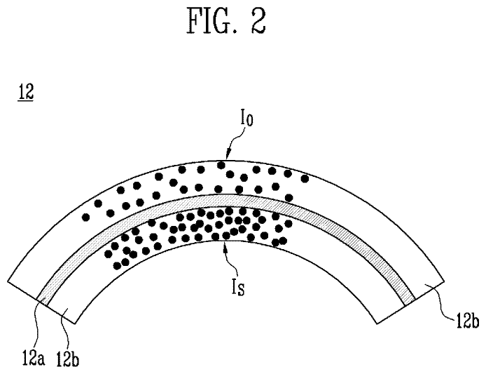

FIG. 2 is a view briefly illustrating at least a part of a structure of a negative electrode 12. Referring to FIG. 2, the negative electrode 12 may include an active material layer 12b on both surfaces of a current collector 12a. However, this is only an example, and the negative electrode 12 may include the active material layer 12b on a cross-section of the current collector 12a. Referring to FIG. 2, the negative electrode 12 is shown being bent, and it can be seen that an inner surface Iₛ where stress due to compression acts and an outer surface Iₒ where stress due to extension acts are formed by the bending.

Although the negative electrode 12 is illustrated, the same applies to the positive electrode 11.

Due to such deterioration, cracks may occur on the surface of the electrode assembly, and lithium plating may occur in specific regions. In addition, the lifespan of a battery after repeated cycles may be reduced by 30% or more compared to the initial state due to the deterioration.

In addition, the electrode (positive electrode or negative electrode) includes an active material layer formed of an electrode slurry on a current collector, and by bending, the density of the active material in the active material layer increases on the inner surface while the density of the active material decreases on the outer surface. As a result, a problem may occur in which electrode densities of the inner surface and the outer surface become different. Referring to FIG. 2, it can be seen that in the outer surface Iₒ portion, the density of the active material decreases due to extension, and in the inner surface Iₛ portion, the density of the active material increases due to compression.

In particular, in the case of the negative electrode, volume expansion and contraction are generally repeated due to charging and discharging, and in addition to stress caused by bending, a force caused by expansion and contraction of volume is also applied. If electrode densities of the inner surface and the outer surface are different, the negative electrode, which has been wound, may be unfolded due to the difference in force caused by expansion of the inner surface and the outer surface. Such a phenomenon may also cause problems such as electrical short-circuit or lithium plating.

In addition, the electrode undergoes elongation due to bending, whereby a cross-sectional area decreases and electrical resistance increases. In addition, as elongation due to bending occurs, the density of the active material decreases, and the distance between the active materials increases, thereby also increasing contact resistance. To solve such a problem, a larger amount of conductive material must be included in the active material layer. However, when the content of the conductive material is increased, the content of the active material decreases, causing a problem of reduced capacity, and even if the content of the conductive material is increased, it is insufficient to improve the increase in resistance caused by physical distance change.

A laminate 300 according to one example of the present disclosure may comprise a metal film 100 and a primer layer 310. The primer layer 310 may be provided on at least one surface of the metal film 100. The primer layer 310 may be provided on one surface or both surfaces of the metal film 100.

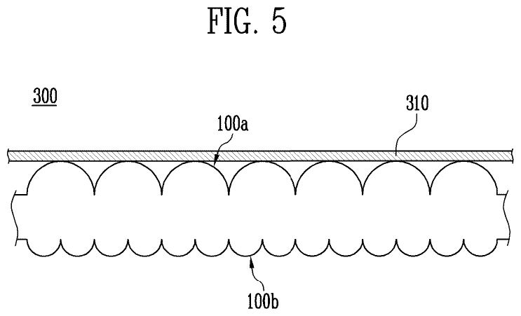

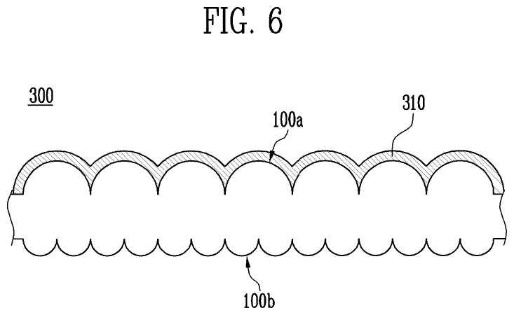

FIGS. 5 and 6 are views exemplarily showing at least a part of a laminate 300 according to one example of the present disclosure.

Referring to FIG. 5, the laminate 300 may comprise a metal film 100 and a primer layer 310 formed on the metal film 100.

The primer layer 310 of the laminate 300 according to one example of the present disclosure may connect the metal film 100 with a component to be connected to the metal film 100. The connection method may include adhesion or attachment. In addition, the primer layer 310 may cover at least a portion of one surface or both surfaces of the metal film 100. Further, the primer layer 310 may not be continuously provided, and may be provided only to an extent sufficient to connect the component to be connected with the metal film 100 on one surface or both surfaces of the metal film 100. In another example, the primer layer 310 may be continuously provided in its entirety. In addition, the primer layer 310 may be an adhesive layer or a pressure-sensitive adhesive layer.

In the laminate 300 according to one example of the present disclosure, the metal film 100 may comprise a first surface 100a and a second surface 100b. The second surface 100b may be an opposite surface to the first surface 100a. The shape of the metal film 100 is not particularly limited as long as the metal film 100 comprises the first surface 100a and the second surface 100b opposite to the first surface 100a.

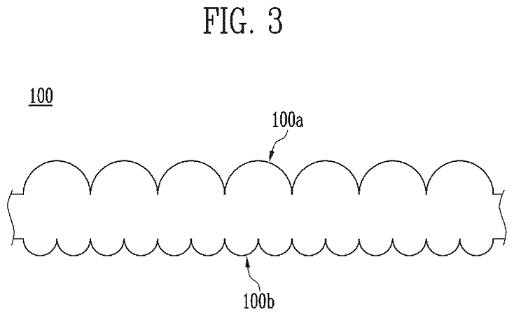

FIG. 3 is a view exemplarily showing at least a part of a metal film 100 according to one example of the present disclosure. Referring to FIG. 3, the metal film 100 comprises a first surface 100a and a second surface 100b opposite to the first surface 100a.

In addition, the metal film 100 may be a current collector of a battery. The current collector may be a positive electrode current collector in the case of the positive electrode, and may be a negative electrode current collector in the case of the negative electrode. The positive electrode current collector is not particularly limited in type, size, or shape as long as it has conductivity without causing a chemical change in the battery. Examples of the positive electrode current collector may include stainless steel, aluminum, nickel, titanium, baked carbon, or those surface-treated with carbon, nickel, titanium, or silver on the surface of aluminum or stainless steel. The negative electrode current collector is not particularly limited in type, size, or shape as long as it has conductivity without causing a chemical change in the battery. Examples of the negative electrode current collector may include copper, stainless steel, aluminum, nickel, titanium, baked carbon, those surface-treated with carbon, nickel, titanium, or silver on the surface of copper or stainless steel, or aluminum-cadmium alloys.

In the laminate 300 according to one example of the present disclosure, the metal film 100 may comprise copper or aluminum. The metal film 100 may comprise copper in an amount of 55% by weight or more, 60% by weight or more, 70% by weight or more, 75% by weight or more, 80% by weight or more, 85% by weight or more, 90% by weight or more, or 95% by weight or more, based on the total weight of the metal film 100. In addition, the metal film 100 may comprise aluminum in an amount of 55% by weight or more, 60% by weight or more, 70% by weight or more, 75% by weight or more, 80% by weight or more, 85% by weight or more, 90% by weight or more, or 95% by weight or more, based on the total weight of the metal film 100. When the metal film 100 comprises copper in the above content range, it may be used as a negative electrode current collector. In addition, when the metal film 100 comprises aluminum in the above content range, it may be used as a positive electrode current collector.

In the laminate 300 according to one example of the present disclosure, the metal film 100 may comprise a halogen element. The term “halogen element” used in the present disclosure refers to an element belonging to Group 17 of the periodic table, and examples may include fluorine (F), chlorine (Cl), bromine (Br), and iodine (I). By comprising a halogen element, the metal film 100 can minimize problems in which the inner surface and the outer surface are respectively deteriorated by stress due to compression and stress due to elongation during bending.

In the laminate 300 according to one example of the present disclosure, the metal film 100 may comprise at least one selected from the group consisting of chlorine and iodine among the halogen elements. By comprising at least one selected from the group consisting of chlorine and iodine, the metal film 100 can minimize problems in which the inner surface and the outer surface are respectively deteriorated by stress due to compression and stress due to elongation during bending.

In the laminate 300 according to one example of the present disclosure, the metal film 100 may comprise chlorine among the halogen elements. The metal film 100 may comprise chlorine in an amount of 1% by weight or more, 2% by weight or more, 3% by weight or more, 4% by weight or more, 5% by weight or more, 6% by weight or more, 7% by weight or more, 8% by weight or more, 9% by weight or more, 10% by weight or more, 11% by weight or more, or 12% by weight or more, based on the total weight. In addition, the metal film 100 may comprise chlorine in an amount of 30% by weight or less, 28% by weight or less, 26% by weight or less, 24% by weight or less, 22% by weight or less, 20% by weight or less, or 18% by weight or less, based on the total weight. Further, the chlorine may be comprised within a range formed by appropriately adopting the above upper and lower limits. When chlorine is comprised within the above content range, the metal film 100 can minimize problems in which the inner surface and the outer surface are respectively deteriorated by stress due to compression and stress due to elongation during bending.

In the laminate 300 according to one example of the present disclosure, the metal film 100 may comprise iodine among the halogen elements. The metal film 100 may comprise iodine in an amount of 0.001% by weight or more, 0.005% by weight or more, 0.01% by weight or more, 0.015% by weight or more, or 0.02% by weight or more, based on the total weight. In addition, the metal film 100 may comprise iodine in an amount of 0.1% by weight or less, 0.09% by weight or less, 0.08% by weight or less, 0.07% by weight or less, 0.06% by weight or less, 0.05% by weight or less, 0.04% by weight or less, or 0.03% by weight or less, based on the total weight. Further, the iodine may be comprised within a range formed by appropriately adopting the above upper and lower limits. When iodine is comprised within the above content range, the metal film 100 can minimize problems in which the inner surface and the outer surface are respectively deteriorated by stress due to compression and stress due to elongation during bending.

In the laminate 300 according to one example of the present disclosure, the metal film 100 may be a rolled metal film 100 or an electrolytic metal film 100. The term “rolled metal film 100” used in the present disclosure means a metal film 100 manufactured by a rolling method. In addition, the term “electrolytic metal film 100” used in the present disclosure means a metal film 100 manufactured by an electroplating method.

In the laminate 300 according to one example of the present disclosure, the metal film 100 may preferably be an electrolytic metal film 100. When the metal film 100 is manufactured by the electroplating method, excellent productivity can be secured while exhibiting favorable physical properties.

In the laminate 300 according to one example of the present disclosure, crystal grains may be formed on the first surface 100a and the second surface 100b of the metal film 100. The metal film 100 may have crystal grains formed on the first surface 100a and the second surface 100b by being manufactured according to a manufacturing method of the laminate 300 described below. The crystal grains may be formed in the case where the metal film is manufactured by the electroplating method.

In the laminate 300 according to an embodiment of the present disclosure, the metal film 100 may have a roughness satisfying a specific numerical range due to the crystal grains. The metal film 100 may have unevenness formed on the surface so as to have a roughness satisfying a specific numerical range.

In the laminate 300 according to one example of the present disclosure, the metal film 100 may have roughness satisfying a specific numerical range by the crystal grains. The metal film 100 may have uneven portions formed on its surface so as to have roughness satisfying a specific numerical range.

In the laminate 300 according to one example of the present disclosure, the first surface 100a and the second surface 100b of the metal film 100 may each independently have roughness satisfying a specific numerical range. In addition, the first surface 100a and the second surface 100b of the metal film 100 may have different roughness. A degree of difference in roughness between the first surface 100a and the second surface 100b may be represented by an R_{aR} value according to Equation 1 below.

In the metal film 100 according to one example of the present disclosure, the R_{aR} according to Equation 1 below may be 100 or more, 101 or more, 102 or more, 103 or more, 104 or more, 105 or more, 106 or more, 107 or more, 108 or more, 109 or more, or 110 or more, or may be 2,000 or less, 1,900 or less, 1,800 or less, 1,700 or less, 1,600 or less, 1,500 or less, 1,400 or less, 1,300 or less, 1,200 or less, 1,100 or less, or 1,000 or less. The R_{aR} according to Equation 1 may be within a range formed by appropriately selecting the above upper and lower limits.

$${R}_{aR} = {R}_{a 1} / {R}_{a 2} \times 100 \qquad [ Equation 1 ]$$

In Equation 1, Rₐ₁ is the arithmetic average roughness (unit: μm) of the first surface 100a, and Rₐ₂ is the arithmetic average roughness (unit: μm) of the second surface 100b.

The term “arithmetic average roughness (Rₐ)” used in the present disclosure is also referred to as “center-line average roughness.” The arithmetic average roughness may be measured by drawing a roughness curve formed on the surface of a measurement target, drawing a mean line (center line) for an evaluation length L, and then calculating an average value of deviations of all peaks and valleys from the mean line. Specifically, the arithmetic average roughness may be measured according to ISO 4287:1997.

In the laminate 300 according to one example of the present disclosure, since the R_{aR} of the metal film 100 according to Equation 1 satisfies a value within the above range, it is possible to minimize problems in which the inner surface and the outer surface are respectively deteriorated by stress due to compression and stress due to elongation during bending, to prevent crack occurrence on the surface and lithium plating phenomenon caused by stress acting during bending, and to prevent reduction of battery lifespan.

The laminate 300 according to one example of the present disclosure may be included in an electrode assembly. The metal film 100 of the laminate 300 may be used as a current collector. The electrode assembly may be formed into a jelly roll by winding. Due to the winding, at least a portion of the electrode assembly is bent, and by the bending, an inner surface where stress due to compression acts and an outer surface where stress due to extension acts are formed.

In the laminate 300 according to one example of the present disclosure, since the R_{aR} of the metal film 100 according to Equation 1 satisfies a value within the above range, it is possible to improve a problem in which electrode densities of the inner surface and the outer surface become different due to bending.

In the laminate 300 according to one example of the present disclosure, the first surface 100a of the metal film 100 may have greater roughness than the second surface 100b. Here, in the metal film 100, the first surface 100a may be made to serve as an outer surface where stress due to extension acts by bending, and the second surface 100b may be made to serve as an inner surface where stress due to compression acts by bending.

In addition, in the laminate 300 according to one example of the present disclosure, the first surface 100a of the metal film 100 may have a larger size of uneven portions than the second surface 100b. The larger size of uneven portions means that an average volume of the uneven portions on each surface is larger. That is, the average volume of the uneven portions on the first surface 100a of the metal film 100 may be larger than the average volume of the uneven portions on the second surface 100b.

In the metal film 100 of the laminate 300 according to one example of the present disclosure, the first surface 100a having relatively greater roughness may be subjected to stress due to extension, and the second surface 100b having relatively smaller roughness than the first surface 100a may be subjected to stress due to compression. Thus, it is possible to minimize problems in which the inner surface and the outer surface are respectively deteriorated by stress due to compression and stress due to extension during bending, to prevent crack occurrence on the surface and lithium plating phenomenon caused by stress acting during bending, and to prevent reduction of battery lifespan.

In the laminate 300 according to one example of the present disclosure, Rₐ₁ of Equation 1 may be 0.1 μm or more, 0.101 μm or more, 0.102 μm or more, 0.103 μm or more, 0.104 μm or more, 0.105 μm or more, 0.106 μm or more, 0.107 μm or more, 0.108 μm or more, 0.109 μm or more, or 0.11 μm or more, or may be 2 μm or less, 1.9 μm or less, 1.8 μm or less, 1.7 μm or less, 1.6 μm or less, 1.5 μm or less, 1.4 μm or less, 1.3 μm or less, 1.2 μm or less, 1.1 μm or less, or 1 μm or less. The Rₐ₁ of Equation 1 may be within a range formed by appropriately selecting the above upper and lower limits. When Rₐ₁ satisfies the above range, in combination with the primer layer 310, it is possible to maintain excellent adhesion with the active material layer while preventing deterioration and crack occurrence caused by stress due to elongation during bending.

In the laminate 300 according to one example of the present disclosure, Rₐ₂ of Equation 1 may be 0.01 μm or more, 0.02 μm or more, 0.03 μm or more, 0.04 μm or more, or 0.05 μm or more, or may be 0.5 μm or less, 0.45 μm or less, 0.4 μm or less, 0.35 μm or less, 0.3 μm or less, 0.25 μm or less, 0.2 μm or less, 0.15 μm or less, or 0.1 μm or less. The Rₐ₂ of Equation 1 may be within a range formed by appropriately selecting the above upper and lower limits. When Rₐ₂ satisfies the above range, in combination with the primer layer 310, it is possible to maintain excellent adhesion with the active material layer while preventing deterioration caused by stress due to compression during bending.

In the laminate 300 according to one example of the present disclosure, the metal film 100 may have a tensile strength of 10 kg/cm² or more, 15 kg/cm² or more, 20 kg/cm² or more, 25 kg/cm² or more, or 30 kg/cm² or more, or may have a tensile strength of 100 kg/cm² or less, 95 kg/cm² or less, 90 kg/cm² or less, 85 kg/cm² or less, or 80 kg/cm² or less. The tensile strength may be within a range formed by appropriately selecting the above upper and lower limits. The tensile strength may be a value measured at 25° C. without pretreatment of the metal film 100. The tensile strength may be measured by preparing a specimen according to a metal thin film tensile test standard (ASTM E345) and performing a tensile test.

In the laminate 300 according to one example of the present disclosure, the metal film 100 may have a bending cycle number until fracture of 3,000 times or more and 10,000 times or less. The bending cycle number may be a value measured at 25° C. without pretreatment of the metal film 100. The bending cycle number may be measured by a bending fatigue test. The bending fatigue test may be performed by preparing the metal film 100 as a rectangular sample with a width of 10 mm and a length of 10 mm, and measuring the number of bending cycles until fracture using a bending tester (bending radius: 1 mm, bending speed: 100 cpm, stroke: 20 mm) according to the measurement method of JIS C 5016.

In the laminate 300 according to one example of the present disclosure, the metal film 100 may have a thickness of 1 μm or more, 1.5 μm or more, 2 μm or more, 2.5 μm or more, 3 μm or more, 3.5 μm or more, 4 μm or more, 4.5 μm or more, 5 μm or more, 5.5 μm or more, or 6 μm or more, or may have a thickness of 500 μm or less, 450 μm or less, 400 μm or less, 350 μm or less, 300 μm or less, 250 μm or less, 200 μm or less, 150 μm or less, 100 μm or less, 50 μm or less, 40 μm or less, 30 μm or less, 20 μm or less, or 10 μm or less. The thickness may be within a range formed by specifying the above upper and lower limits.

In the laminate 300 according to one example of the present disclosure, the primer layer 310 may have a thickness of 0.5 μm or more, 1 μm or more, 1.5 μm or more, 2 μm or more, 2.5 μm or more, or 3 μm or more, or may have a thickness of 30 μm or less, 25 μm or less, 20 μm or less, 15 μm or less, 10 μm or less, 9 μm or less, 8 μm or less, 7 μm or less, 6 μm or less, 5 μm or less, 4 μm or less, or 3 μm or less. The thickness may be within a range formed by specifying the above upper and lower limits.

In the laminate 300 according to one example of the present disclosure, the primer layer 310 may comprise a copolymer. The copolymer may be a component serving as a material of an adhesive or a pressure-sensitive adhesive. By including the copolymer, the primer layer 310 may have adhesive or pressure-sensitive adhesive functions. The copolymer may be an alternating copolymer, a random copolymer, a block copolymer, or a graft copolymer. The type of copolymer is not particularly limited, and an appropriate type may be selected and used as needed.

In the primer layer 310 of the laminate 300 according to one example of the present disclosure, the copolymer may comprise a first unit, a second unit, and a third unit. In addition, the copolymer may further comprise other units in addition to the above three units. The term “unit of copolymer” used in the present disclosure refers to a repeating unit derived from a monomer when a polymer is produced based on the monomer. Specifically, the units of the copolymer may mean repeating units derived from each monomer when one or more monomers are (co)polymerized. The copolymer may include at least three or more units.

In the primer layer 310 of the laminate 300 according to one example of the present disclosure, the copolymer may comprise a first unit containing an aromatic group, a second unit being an alkylene group, and a third unit being an alkylene group different from the second unit. The first unit may include the aromatic group as a substituent. In addition, the alkylene groups of the second unit and the third unit may each independently be substituted with substituents or unsubstituted. Furthermore, the fact that the alkylene group of the second unit and the alkylene group of the third unit are different means that the number of carbon atoms in the main chain of each alkylene group is different, or even if the number of carbon atoms in the main chain is the same, their structures are different. By comprising a copolymer including the first unit to the third unit in the primer layer 310 of the laminate 300 according to one example of the present disclosure, it is possible to improve the problem of increased resistance occurring due to elongation caused by bending.

In the copolymer, assuming that the alkylene group of the second unit and the alkylene group of the third unit are different from each other, each may independently be a straight-chain or branched-chain alkylene group having 1 to 20 carbon atoms, or 1 to 16 carbon atoms, or 1 to 12 carbon atoms, or 1 to 8 carbon atoms, or 1 to 6 carbon atoms, or may be a cyclic alkylene group having 3 to 20 carbon atoms, or 3 to 16 carbon atoms, or 3 to 12 carbon atoms, or 3 to 8 carbon atoms, or 3 to 6 carbon atoms.

The number of carbon atoms refers to the number of carbon atoms in the main chain excluding the number of carbon atoms in substituents. In another example, assuming that the alkylene group of the second unit and the alkylene group of the third unit are different from each other, each may independently be a straight-chain or branched-chain alkylene group having 2 to 20 carbon atoms, or 2 to 16 carbon atoms, or 2 to 12 carbon atoms, or 2 to 8 carbon atoms, or 2 to 6 carbon atoms, or may be a cyclic alkylene group having 3 to 20 carbon atoms, or 3 to 16 carbon atoms, or 3 to 12 carbon atoms, or 3 to 8 carbon atoms, or 3 to 6 carbon atoms.

In the copolymer, the number of carbon atoms (N_{C2}) of the alkylene group of the second unit may be smaller than the number of carbon atoms (N_{C3}) of the alkylene group of the third unit. Here, the number of carbon atoms (N_{C2}) of the second unit may refer to the number of carbon atoms in the main chain of the second unit. In addition, the number of carbon atoms (N_{C3}) of the third unit may refer to the number of carbon atoms in the main chain of the third unit.

In the copolymer, the ratio (N_{C2}/N_{C3}) of the number of carbon atoms in the main chain of the second unit (N_{C2}) to the number of carbon atoms in the main chain of the third unit (N_{C3}) may be 0.1 or more, 0.15 or more, 0.2 or more, 0.25 or more, 0.3 or more, 0.35 or more, 0.4 or more, 0.45 or more, or 0.5 or more; or 1 or less, 0.95 or less, 0.9 or less, 0.85 or less, 0.8 or less, 0.75 or less, 0.7 or less, 0.65 or less, 0.6 or less, or 0.55 or less; or a value within a range formed by selecting the above upper and lower limits. When the carbon number ratio (N_{C2}/N_{C3}) of the copolymer satisfies the above range, it is possible to improve the problem of increased resistance occurring due to elongation caused by bending.

In the copolymer, the aromatic group contained in the first unit may be substituted or unsubstituted. The aromatic group may include one or more selected from the group consisting of aryl groups and heteroaryl groups. Considering the effects of the present disclosure, it is preferable that the first unit contains an aryl group. The aryl group contained in the first unit may be an aryl group having 6 to 30 carbon atoms, or 6 to 26 carbon atoms, or 6 to 22 carbon atoms, or 6 to 20 carbon atoms, or 6 to 18 carbon atoms, or 6 to 15 carbon atoms. The number of carbon atoms refers to the number of carbon atoms of the aryl group itself (i.e., the main chain), excluding the number of carbon atoms in substituents of the aryl group. The heteroaryl group contained in the first unit may be a heteroaryl group having 2 to 30 carbon atoms, or 2 to 26 carbon atoms, or 2 to 22 carbon atoms, or 2 to 20 carbon atoms, or 2 to 18 carbon atoms, or 2 to 15 carbon atoms, or a heteroaryl group having 5 to 30 ring atoms, 5 to 25 ring atoms, 5 to 20 ring atoms, 5 to 15 ring atoms, 5 to 10 ring atoms, or 5 to 8 ring atoms. The number of carbon atoms or ring atoms refers to the number of carbon atoms or ring atoms of the heteroaryl group itself (i.e., the main chain), excluding the number of carbon atoms or ring atoms in substituents of the heteroaryl group.

In the copolymer, the first unit may be an alkylene group containing one or more aromatic groups. The alkylene group of the first unit may be a straight-chain or branched-chain alkylene group having 1 to 20 carbon atoms, or 1 to 16 carbon atoms, or 1 to 12 carbon atoms, or 1 to 8 carbon atoms, or 1 to 6 carbon atoms, or may be a cyclic alkylene group having 3 to 20 carbon atoms, or 3 to 16 carbon atoms, or 3 to 12 carbon atoms, or 3 to 8 carbon atoms, or 3 to 6 carbon atoms. The number of carbon atoms refers to the number of carbon atoms in the main chain, excluding the number of carbon atoms in substituents. In another example, in the copolymer, the alkylene group of the first unit may be a straight-chain or branched-chain alkylene group having 2 to 20 carbon atoms, or 2 to 16 carbon atoms, or 2 to 12 carbon atoms, or 2 to 8 carbon atoms, or 2 to 6 carbon atoms, or may be a cyclic alkylene group having 3 to 20 carbon atoms, or 3 to 16 carbon atoms, or 3 to 12 carbon atoms, or 3 to 8 carbon atoms, or 3 to 6 carbon atoms.

In the copolymer, the ratio (N_{C1}/N_{C2}) of the number of carbon atoms of the alkylene group of the first unit (N_{C1}) to the number of carbon atoms of the alkylene group of the second unit (N_{C2}) may be 0.5 or more, 0.55 or more, 0.6 or more, 0.65 or more, 0.7 or more, 0.75 or more, 0.8 or more, 0.85 or more, 0.9 or more, 0.95 or more, or 1 or more; or 2 or less, 1.9 or less, 1.8 or less, 1.7 or less, 1.6 or less, 1.5 or less, 1.4 or less, 1.3 or less, 1.2 or less, or 1.1 or less; or a value within a range formed by selecting the above upper and lower limits. The number of carbon atoms of the alkylene group of the first unit (N_{C1}) may refer to the number of carbon atoms of the alkylene group itself as the main chain of the first unit. Similarly, the number of carbon atoms of the alkylene group of the second unit (N_{C2}) may refer to the number of carbon atoms of the alkylene group itself as the main chain of the second unit. When the carbon number ratio (N_{C1}/N_{C2}) in the copolymer satisfies the above range, it is possible to improve the problem of increased resistance occurring due to elongation caused by bending.

In addition, the copolymer may have a weight-average molecular weight (Mw) within the range of 10,000 to 30,000 g/mol or within the range of 15,000 to 25,000 g/mol. In addition, the copolymer may have a polydispersity index (PDI) within the range of 1 to 2, within the range of 1.2 to 1.8, or within the range of 1.4 to 1.6. When the weight-average molecular weight (Mw) and polydispersity index (PDI) of the copolymer satisfy the above ranges, it is possible to improve the problem of increased resistance occurring due to elongation caused by bending.

The term “weight-average molecular weight (Mw)” used in the present disclosure can be measured using GPC (Gel Permeation Chromatography), and specifically may be measured according to the following method. In addition, the term “polydispersity index (PDI)” used in the present disclosure refers to a value obtained by dividing the weight-average molecular weight (Mw) by the number-average molecular weight (Mn) (Mw/Mn), and indicates the molecular weight distribution of the polymer. The number-average molecular weight (Mn) may also be measured using GPC (Gel Permeation Chromatography) as needed.

Specifically, the weight-average molecular weight (Mw) or number-average molecular weight (Mn) may be measured as follows: An analysis sample is placed in a 5 mL vial and diluted with tetrahydrofuran (THF) solvent to a concentration of about 1 mg/mL. Both the calibration standard sample and the analysis sample are filtered through a syringe filter having a pore size of 0.45 μm and then measured. The analysis program used is ChemStation by Agilent Technologies. The elution time of the sample is compared with a calibration curve to determine the weight-average molecular weight (Mw).

### <GPC Measurement Conditions>

Instrument: Agilent Technologies 1200 series
Columns: Agilent Technologies TL Mix. A & B
Solvent: THF (tetrahydrofuran)
Column temperature: 35° C.
Sample concentration: 1 mg/mL, injection volume 200 L
Standard samples: Polystyrene standards (MP: 3,900,000; 723,000; 316,500; 52,200; 31,400; 7,200; 3,940; 485)

Generally, the primer layer 310 may be formed by coating a polymer such as PVDF or PVDF-HFP with a thickness of 1 to 5 μm. In contrast, in the present disclosure, the primer layer 310 is formed using a composite of SEBS (Styrene-Ethylene-Butylene-Styrene) and CNT (carbon nanotubes) among copolymers. A composition for the primer layer was prepared in the form of a dispersion, and the solvent may be any one of non-polar solvents such as benzene, toluene, hexane, and cyclohexane. For forming the primer layer, the manufacturing method according to the present disclosure may use slot die coating or gravure coating.

The primer layer 310 may comprise the copolymer in an amount of 50% by weight or more, 55% by weight or more, 60% by weight or more, or 65% by weight or more based on the total weight of the primer layer, and may be included within a range of 70% by weight or less.

The manufacturing method according to the present disclosure performed a drying step to dry a composition for the primer layer applied onto the metal film 100 at a high temperature for forming the primer layer 310. The drying may be performed by vaporizing or evaporating the solvent in a high-temperature oven or by hot air drying. For example, the high temperature may be 80° C. (Celsius). For forming the primer layer, the manufacturing method according to the present disclosure may use slot die coating or gravure coating.

In addition, through the applying and drying processes, a ripple pattern or uneven pattern may be formed. Alternatively, the metal film may have the ripple pattern or uneven pattern formed in advance.

In the laminate 300 according to one example of the present disclosure, the metal film 100 may include one or more uneven portions on its surface. In addition, the primer layer 310 of the laminate 300 may be formed to cover one or more of the uneven portions. As described above, when some surfaces are stretched due to bending, the density of the active material and conductive material in the active material layer decreases, suppressing electron flow and thereby increasing resistance. When the primer layer 310 covers one or more of the uneven portions, it can prevent density reduction even during stretching, thereby improving the problem of resistance increase. The primer layer 310 being formed to cover the uneven portions means that at least a portion of the surface of the uneven portions is in contact with the primer layer 310 so that the surface of the uneven portions is not exposed to the outside.

Referring to FIG. 6, it can be seen that the primer layer 310 covers all the uneven portions on the surface of the metal film 100. In addition, the primer layer 310 may cover one or more, preferably all, of the uneven portions and may cover at least a portion of the metal film 100.

In the laminate 300 according to one example of the present disclosure, the surface of the primer layer 310 may be flat. In another example, the surface of the primer layer 310 may have a pattern. The surface of the primer layer 310 refers to the surface opposite to the surface in contact with the metal film 100. The pattern that the surface of the primer layer 310 may have may be based on a predetermined rule or may be randomly formed without any specific rule.

In the laminate 300 according to one example of the present disclosure, the surface of the primer layer 310 may have a pattern in which protrusions and recesses are repeatedly arranged. The pattern of repeating protrusions and recesses may be referred to as a ripple pattern. By having the primer layer 310 surface with the above pattern, it is possible to improve the problem of increased resistance occurring due to elongation caused by bending. The pattern of repeating protrusions and recesses may have the width and height of the protrusions and the width and depth of the recesses arranged in a regular pattern, or the widths and heights of the protrusions and the widths and depths of the recesses may be arranged randomly. Alternatively, a portion may be regularly arranged while another portion is arranged randomly. The width and height of the protrusions and the width and depth of the recesses may be appropriately controlled according to the purpose. Referring to FIG. 6, it can be seen that the surface of the primer layer 310 has a pattern in which protrusions and recesses are repeatedly arranged.

In the laminate 300 according to one example of the present disclosure, the primer layer 310 may be formed to cover one or more uneven portions present on the surface of the metal film, and the surface of the primer layer 310 may have a pattern in which protrusions and recesses are repeatedly arranged. ere, the surface of the primer layer 310 refers to the surface opposite to the surface in contact with the metal film 100. When the primer layer 310 is formed as described above, it is possible to improve the problem of increased resistance occurring due to elongation caused by bending.

In the laminate 300 according to one example of the present disclosure, the primer layer 310 may further comprise a conductive material. The conductive material is not particularly limited as long as it has conductivity without causing chemical changes. For example, the conductive material may include graphite such as natural graphite or artificial graphite; carbon blacks such as carbon black, acetylene black, ketjen black, channel black, furnace black, lamp black, and thermal black; conductive fibers such as carbon fibers or metal fibers; conductive tubes such as carbon nanotubes (CNT); metal powders such as fluorocarbon, aluminum, or nickel powder; conductive whiskers such as zinc oxide or potassium titanate; conductive metal oxides such as titanium oxide; conductive materials such as polyphenylene derivatives; and the like. The primer layer 310 may comprise carbon nanotubes (CNT) as the conductive material. By including the conductive material in the primer layer 310, electrical conductivity can be further improved, and the problem of resistance increase due to bending can be improved. In one embodiment, the primer layer 310 may comprise the conductive material in an amount of 5% by weight or more, 10% by weight or more, 15% by weight or more, 20% by weight or more, 25% by weight or more, or 30% by weight or more based on the total weight of the primer layer, and may be included within a range of 50% by weight or less, 60% by weight or less, or 70% by weight or less.

The laminate 300 according to one example of the present disclosure may be manufactured by the manufacturing method of the laminate 300 described below. The manufacturing method of the laminate 300 may include a step of forming the primer layer 310. The step of forming the primer layer 310 may be a step of forming the primer layer 310 including the copolymer on at least one surface of the metal film 100. Since the copolymer is the same as the copolymer included in the primer layer 310 of the laminate 300 according to one example of the present disclosure described above, its detailed description is omitted.

Generally, the primer layer 310 may be formed by coating a polymer such as PVDF or PVDF-HFP with a thickness of 1 to 5 μm. In contrast, in the present disclosure, the primer layer 310 is formed using a composite of SEBS (Styrene-Ethylene-Butylene-Styrene) and CNT (carbon nanotubes) among copolymers. The composition for the primer layer was prepared in the form of a dispersion, and the solvent may be any one of non-polar solvents such as benzene, toluene, hexane, and cyclohexane. The manufacturing method according to the present disclosure performed a drying process at a high temperature for forming the primer layer 310. The drying may be performed by vaporizing or evaporating the solvent in a high-temperature oven or by performing hot air drying. For example, the high temperature may be 80° C. (Celsius).

The manufacturing method of the laminate 300 according to one example of the present disclosure may include a method of manufacturing the metal film 100. In the step of forming the primer layer 310 in the manufacturing method of the laminate 300, the metal film 100 may be manufactured by the manufacturing method of the metal film 100. That is, in the manufacturing method of the laminate 300 according to one example of the present disclosure, the metal film 100 may be manufactured by the manufacturing method of the metal film 100 described below. In addition, the manufacturing method of the laminate 300 according to one example of the present disclosure may include a step of manufacturing the metal film before the step of forming the primer layer. The step of manufacturing the metal film 100 in the present disclosure may be described by the manufacturing method of the metal film 100.

In the manufacturing method of the laminate 300 according to one example of the present disclosure, the method of manufacturing the metal film 100 includes a step of contacting at least a portion of a metal sheet 200, comprising a first surface 200a and a second surface 200b, with a first electrolyte 120 containing metal ions to produce the metal film 100. The metal film 100 may be manufactured by being drawn out.

The second surface 200b of the metal sheet 200 may be the opposite surface to the first surface 200a. Here, the metal film 100 refers to the state of the metal sheet 200 after treatment with the first electrolyte 120. The first surface 200a of the metal sheet 200 corresponds to the first surface 100a of the metal film 100, and the second surface 200b of the metal sheet 200 corresponds to the second surface 100b of the metal film 100.

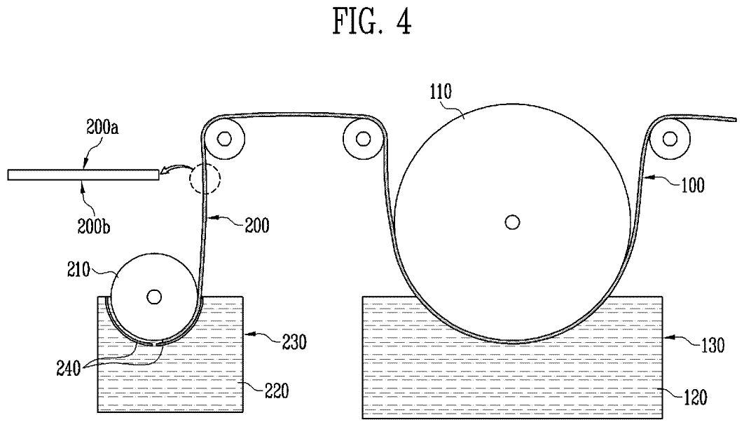

FIG. 4 is a view briefly illustrating a manufacturing process of a metal film 100 according to one example of the present disclosure. Referring to FIG. 4, the metal sheet 200 is at least partially contacted with the first electrolyte 120 while being drawn as the metal film 100. The metal sheet 200 may be conveyed through one or more rollers. In addition, the metal sheet 200 is conveyed while one surface is in contact with the first drum 110, and the other surface, which is not in contact with the drum 110, contacts the first electrolyte 120, thereby being manufactured into the metal film 100. The metal film 100 may be drawn out through one or more rollers. The metal sheet 200 may be conveyed while at least a portion of one surface is in close contact with the first drum 110, or in another example, while the entire surface is in close contact with the first drum 110.

In the manufacturing method of the metal film 100, the first surface 200a of the metal sheet 200 may react with the first electrolyte 120. In addition, the second surface 200b of the metal sheet 200 may substantially not react with the first electrolyte 120.

The first surface 200a of the metal sheet 200 reacting with the first electrolyte 120 means that a physical or chemical change has occurred such that the surface property difference of the first surface 200a is 5% or more.

The surface property is not limited but may be, for example, the amplitude length of the unevenness having the peak farthest from a reference point among the unevennesses formed on the surface. The reference point may refer to the average amplitude line (center line). That is, when the difference between the amplitude length (L1) of the unevenness having the peak farthest from the reference point among the unevennesses formed on the surface before the metal sheet 200 reacts with the first electrolyte 120 and the amplitude length (L2) of the unevenness having the peak farthest from the reference point among the unevennesses formed on the surface after the metal sheet 200 reacts with the first electrolyte 120 is 5% or more, it can be considered that the metal sheet 200 reacts with the first electrolyte 120.

Further, the fact that the second surface 200b of the metal sheet 200 substantially does not react with the first electrolyte 120 means that the second surface 200b does not completely fail to react, but only minor physical or chemical changes occur, resulting in a surface property difference of less than 5%. In other words, “substantially does not react” includes not only no reaction at all but also minor changes occurring due to natural contact rather than intentional reaction. For example, when the difference between the amplitude length (L1) of the unevenness having the peak farthest from the reference point among the unevennesses formed on the surface before the metal sheet 200 reacts with the first electrolyte 120 and the amplitude length (L2) of the unevenness having the peak farthest from the reference point among the unevennesses formed on the surface after the metal sheet 200 reacts with the first electrolyte 120 is less than 5%, it can be considered that the second surface 200b substantially does not react with the first electrolyte 120.

Referring to FIG. 4, the metal sheet 200 may be conveyed with one surface in contact with the first drum 110. The second surface 200b of the metal sheet 200 may be brought into contact with the first drum 110, and the first surface 200a of the metal sheet 200 may be brought into contact with the first electrolyte 120. Through this method, the first surface 200a of the metal sheet 200 reacts with the first electrolyte 120, while the second surface 200b minimizes reaction with the first electrolyte 120, thereby enabling the manufacture of the metal film 100 having different roughnesses on the first surface 100a and the second surface 100b.

In the manufacturing method of the metal film 100, it is preferable that the second surface 200b of the metal sheet 200 is in close contact with the first drum 110. By closely contacting the second surface 200b of the metal sheet 200 to the first drum 110, the reaction between the second surface 200b and the first electrolyte 120 can be minimized.

Referring to FIG. 4, in the manufacturing method of the metal film 100, the first electrolyte 120 is contained in an internal space of the first electrolyte tank 130, and the metal sheet 200 can be at least partially contacted with the first electrolyte 120 through the first drum 110.

In the manufacturing method of the metal film 100, the first electrolyte 120 may include metal ions. The metal ions may be ions of the metal contained in the metal sheet 200. In another example, the metal ions may be ions of the main component metal contained in the metal sheet 200. The term “main component metal” used in the present disclosure may refer to a metal included in an amount of 55% by weight or more based on the total weight of the metal. The term “main component” used in the present disclosure may refer to a component included in an amount of 55% by weight or more based on the total weight.

The metal ions contained in the first electrolyte 120 may be ions of ionizable metals that can be used as a positive electrode current collector or a negative electrode current collector. Specifically, the metal ions may exist in ionic form in an aqueous solution. In one example, the metal ions contained in the first electrolyte 120 may be aluminum ions or copper ions. In another example, the copper ions contained in the first electrolyte 120 may have a concentration of about 50 g/L to 100 g/L.

In the manufacturing method of the metal film 100, the first electrolyte 120 may further include ions of halogen elements. Specifically, to create a difference in surface properties between the first surface 200a and the second surface 200b of the metal sheet 200, the first electrolyte 120 may include one or more selected from the group consisting of chloride ions and iodide ions among the halogen element ions.

In the manufacturing method of the metal film 100, the first electrolyte 120 may include chloride ions. The first electrolyte 120 may contain the chloride ions at a concentration in the range of 0.1 mg/L to 1 mg/L. By including chloride ions at a concentration within this range, it is possible to manufacture the metal film 100 that minimizes the problem of degradation of the inner surface and outer surface due to compression stress and tensile stress during bending, respectively.

In the manufacturing method of the metal film 100, the first electrolyte 120 may include iodide ions. The first electrolyte 120 may contain the iodide ions at a concentration of 1 mg/L or more, 1.5 mg/L or more, 2 mg/L or more, 2.5 mg/L or more, 3 mg/L or more, 3.5 mg/L or more, 4 mg/L or more, 4.5 mg/L or more, or 5 mg/L or more. In another example, the first electrolyte 120 may contain the iodide ions at a concentration of 10 mg/L or less, 9.5 mg/L or less, 9 mg/L or less, 8.5 mg/L or less, 8 mg/L or less, 7.5 mg/L or less, 7 mg/L or less, 6.5 mg/L or less, 6 mg/L or less, or 5.5 mg/L or less. In another example, the first electrolyte 120 may contain the iodide ions within a range appropriately selected from the above upper and lower limits. By including iodide ions at a concentration within the above range, it is possible to manufacture the metal film 100 that minimizes the problem of degradation of the inner surface and outer surface due to compression stress and tensile stress during bending, respectively.

In the manufacturing method of the metal film 100, the first electrolyte 120 may include electrolyte ions that perform an electrolyte function. The electrolyte ions may be spectator ions that do not participate in the physical or chemical reactions of the metal ions or halogen ions contained in the first electrolyte 120. Any ions having such characteristics may be used without limitation, but for example, the first electrolyte 120 may include sulfate ions. In one example, the sulfate ions contained in the first electrolyte 120 may have a concentration of about 100 g/L to 150 g/L.

In the manufacturing method of the metal film 100, the method of obtaining the metal sheet 200 is not particularly limited. The metal sheet 200 may be manufactured by an electroplating method using a second electrolyte 220 containing metal ions. The electroplating method involves bringing a drum serving as a negative electrode into contact with an electrolyte solution and manufacturing the current collector by peeling off a metal thin film sheet deposited on the drum. The power applied in the electroplating method may be approximately in the range of 30 A/dm² to 120 A/dm².

Referring to FIG. 4, the metal sheet 200 may be manufactured by arranging a rotating second drum 210 and an insoluble electrode plate 240 below it, such that the second electrolyte 220 is positioned between the second drum 210 and the insoluble electrode plate 240. The metal sheet 200 may be manufactured by using the second drum 210 as a negative electrode and the insoluble electrode plate 240 as a positive electrode, and applying a current between the second drum 210 and the insoluble electrode plate 240, causing metal to be deposited on the surface of the second drum 210 as negative electrode.

Referring to FIG. 4, in the manufacturing method of the metal film 100, the second electrolyte 220 is contained within the internal space of the second electrolyte tank 230, and the metal sheet 200 can be manufactured through the second drum 210 and the insoluble electrode plate 240.

In the manufacturing method of the metal film 100, the material of the second drum 210 is not particularly limited as long as it has low adhesion strength with the metal sheet 200 being formed and has a natural oxide film. The material of the second drum 210 may include one or more selected from the group consisting of titanium, stainless steel, nickel, and carbon. In the manufacturing method of the metal film 100, it is preferable that the second drum 210 is formed of titanium.

In the manufacturing method of the metal film 100, the insoluble electrode plate 240 may be made of a material insoluble in the second electrolyte 220. The term “insoluble” as used in the present disclosure means a characteristic of dissolving 0.01 mol or less in 1 liter of a solvent.

The insoluble electrode plate 240 may include the metal contained in the metal sheet 200 to be formed. Specifically, the insoluble electrode plate 240 may include the main component metal contained in the metal sheet 200 to be formed. In addition, the insoluble electrode plate 240 may contain the main component metal in an amount of 55% by weight or more, 60% by weight or more, 65% by weight or more, 70% by weight or more, 75% by weight or more, 80% by weight or more, 85% by weight or more, 90% by weight or more, 95% by weight or more, or 99% by weight or more based on the total weight of the insoluble electrode plate 240.

For example, when the main component metal of the metal sheet 200 to be formed is copper, the insoluble electrode plate 240 may include copper as the main component. Likewise, when the main component metal of the metal sheet 200 to be formed is aluminum, the insoluble electrode plate 240 may include aluminum as the main component.

In addition, the insoluble electrode plate 240 may be coated with a metal oxide.

In the manufacturing method of the metal film 100, the second electrolyte 220 may include metal ions. The metal ions may be selected in consideration of the metal sheet 200 being formed.

The metal ions contained in the second electrolyte 220 may be ions of ionizable metals that can be used as a positive electrode current collector or a negative electrode current collector. Specifically, the metal ions may exist in ionic form in an aqueous solution. In one example, the metal ions contained in the second electrolyte 220 may be aluminum ions or copper ions. In another example, the copper ions contained in the second electrolyte 220 may have a concentration of about 50 g/L to 100 g/L.

In the manufacturing method of the metal film 100, the second electrolyte 220 may include electrolyte ions that perform an electrolyte function. The electrolyte ions may be spectator ions that do not participate in the physical or chemical reactions of the metal ions contained in the second electrolyte 220. Any ions having such characteristics may be used without limitation, but for example, the second electrolyte 220 may include sulfate ions. In one example, the sulfate ions contained in the second electrolyte 220 may have a concentration of about 100 g/L to 150 g/L.

In the manufacturing method of the metal film 100, the second electrolyte 220 may include gelatin. By including the gelatin, a metal sheet 200 having crystal grains formed on its surface can be manufactured. The metal film 100 according to one example of the present disclosure can be manufactured through the aforementioned process using the metal sheet 200 having the crystal grains.

The gelatin included in the second electrolyte 220 may have a weight-average molecular weight of about 20,000 g/mol to 160,000 g/mol. When gelatin having a weight-average molecular weight within the aforementioned range is used, the surface of the crystal grains can be formed into a curved surface close to a spherical shape, thereby securing adhesion with the active material layer later.

In the manufacturing method of the metal film 100, when manufacturing the metal sheet 200, the current density between the second drum 210 and the insoluble electrode plate 240 may be within a range of 30 A/dm² to 150 A/dm². By controlling the current density within the aforementioned range, a metal sheet 200 having an appropriate thickness and strength can be manufactured.

In the manufacturing method of the metal film 100, when manufacturing the metal sheet 200, the temperature (specifically, the temperature of the second electrolyte 220) may be from 45° C. to 60° C.

By controlling the temperature within the aforementioned range, a metal sheet 200 having an appropriate thickness and strength can be manufactured.

The thickness of the metal sheet 200 may be 1 μm or more, 1.5 μm or more, 2 μm or more, 2.5 μm or more, 3 μm or more, 3.5 μm or more, 4 μm or more, 4.5 μm or more, 5 μm or more, 5.5 μm or more, 6 μm or more, or 8 μm or more; or 500 μm or less, 450 μm or less, 400 μm or less, 350 μm or less, 300 μm or less, 250 μm or less, 200 μm or less, 150 μm or less, 100 μm or less, 50 μm or less, 40 μm or less, 30 μm or less, 20 μm or less, or 10 μm or less; or within a range specifically defined by the above upper and lower limits.

Referring to FIG. 4, an example of manufacturing a metal film 100 containing copper will be described through a series of processes. This is merely an example, and the present disclosure is not limited thereto.

Referring to FIG. 4, the second electrolyte tank 230 may contain the second electrolyte 220. The second electrolyte 220 may include sulfuric acid, copper ions, and gelatin. The second drum 210 is disposed within the internal space of the second electrolyte tank 230 so as to be in contact with the second electrolyte 220. In addition, an insoluble electrode plate 240 is provided at a location not far from the second drum 210. Here, the insoluble electrode plate 240 may be a copper coating coated with iridium oxide (IrO₂).

By using the rotating second drum 210 as a negative electrode and the insoluble electrode plate 240 as a positive electrode, and by passing current between them, copper metal is deposited on the surface of the cathodic second drum 210, thereby manufacturing a thin metal sheet 200. The metal sheet 200 manufactured on the second drum 210 may be separated and conveyed by one or more rollers.

The conveyed metal sheet 200 has one surface (the second surface, 200b) in close contact with the rotating first drum 110 and is brought into contact with the first electrolyte 120 contained in the first electrolyte tank 130. The surface of the metal sheet not in contact with the first drum 110 (i.e., the first surface, 200a) reacts with the first electrolyte 120. The first electrolyte 120 may include sulfuric acid and copper ions.

As a result, a metal film 100 including the first surface 100a that has reacted with the first electrolyte 120 and the second surface 100b that has substantially not reacted with the first electrolyte 120 is manufactured.

In the manufacturing method of the laminate 300 according to one example of the present disclosure, the metal film 100 according to one example of the present disclosure can be manufactured through the metal film 100 manufacturing method. The physical characteristics of the metal film 100 are as described above.

The electrode according to one example of the present disclosure may include the laminate 300 according to one example of the present disclosure and an active material layer. The active material layer may be formed on at least one outermost surface of the laminate 300. That is, the active material layer may be formed on one or both surfaces of the outermost part of the laminate 300. The metal film 100 of the laminate 300 may serve as a current collector.

In the electrode according to one example of the present disclosure, the current collector may be the metal film 100 of the laminate 300 according to one example of the present disclosure. By using the laminate 300 including the metal film 100, the electrode can minimize the degradation problems of the inner surface and outer surface caused by compressive stress and tensile stress during bending, thereby preventing reduction in battery life, and can improve the problem of increased resistance caused by elongation due to bending.

Further, the battery according to one example of the present disclosure may include the electrode and a separator 13.

In the electrode according to one example of the present disclosure, the active material layer may refer to a layer in which the slurry has been dried and the solvent removed, or a layer formed through a rolling process after drying. The active material layer may have a thickness of 1 to 200 μm.

The slurry may include an electrode active material and a binder.

The electrode active material may be included in an amount of about 80% by weight or more, 81% by weight or more, 82% by weight or more, 83% by weight or more, 84% by weight or more, 85% by weight or more, 86% by weight or more, 87% by weight or more, or 88% by weight or more, or 99% by weight or less, or 98% by weight or less based on the total solids weight of the slurry.

The binder may be included in an amount of 0.1 parts by weight or more, 0.2 parts by weight or more, 0.3 parts by weight or more, 0.4 parts by weight or more, 0.5 parts by weight or more, 0.6 parts by weight or more, 0.7 parts by weight or more, 0.8 parts by weight or more, 0.9 parts by weight or more, or 1 part by weight or more, or 10 parts by weight or less, 9.5 parts by weight or less, 9 parts by weight or less, 8.5 parts by weight or less, 8 parts by weight or less, 7.5 parts by weight or less, 7 parts by weight or less, 6.5 parts by weight or less, 6 parts by weight or less, 5.5 parts by weight or less, 5 parts by weight or less, 4.5 parts by weight or less, 4 parts by weight or less, 3.5 parts by weight or less, 3 parts by weight or less, 2.5 parts by weight or less, or 2 parts by weight or less, based on 100 parts by weight of the electrode active material.

There is no particular limitation on the specific type of the binder, and a substance that generally serves to improve adhesion between electrode active materials and adhesion between the electrode active material and the electrode current collector may be used.

The type of the binder is not particularly limited. For example, one or more selected from the group consisting of polyvinylidene fluoride (PVDF), polyvinyl alcohol, styrene butadiene rubber (SBR), polyethylene oxide, carboxyl methyl cellulose (CMC), cellulose acetate, cellulose acetate butylate, cellulose acetate propionate, cyanoethyl pullulan, cyanoethyl polyvinyl alcohol, cyanoethyl cellulose, cyanoethyl sucrose, pullulan, polymethyl methacrylate, polybutyl acrylate, polyacrylonitrile, polyvinylpyrrolidone, polyvinyl acetate, polyethylene-co-vinyl acetate copolymer, polyarylate, and low molecular weight compounds having a molecular weight of 10,000 g/mol or less may be used.

The slurry may further include a conductive material. The conductive material is not particularly limited as long as it has conductivity without causing chemical changes in the battery. For example, the conductive material may include graphite such as natural graphite or artificial graphite; carbon blacks such as carbon black, acetylene black, ketjen black, channel black, furnace black, lamp black, and thermal black; conductive fibers such as carbon fibers or metal fibers; conductive tubes such as carbon nanotubes (CNT); metal powders such as fluorocarbon, aluminum, or nickel powders; conductive whiskers such as zinc oxide or potassium titanate; conductive metal oxides such as titanium oxide; conductive materials such as polyphenylene derivatives; and the like.

The conductive material may be included in an amount of 0.1 parts by weight to 5 parts by weight, or 0.5 parts by weight to 2 parts by weight, based on 100 parts by weight of the electrode active material, but is not limited thereto. The method of determining an appropriate content of the conductive material considering the cycle life of the battery is well known.

The slurry may optionally further include a solvent. The solvent is not particularly limited as long as it is commonly used in the art, and examples thereof include water, isopropyl alcohol, N-methylpyrrolidone (NMP), and acetone.

Further, the electrode may be a positive electrode or a negative electrode. The positive electrode may include a positive electrode current collector and a positive electrode active material layer formed from a positive electrode slurry. The negative electrode may include a negative electrode current collector and a negative electrode active material layer formed from a negative electrode slurry.

The positive electrode slurry may include a positive electrode active material. The positive electrode active material is not particularly limited, but examples thereof include layered compounds such as lithium cobalt oxide (LiCoO₂) and lithium nickel oxide (LiNiO₂), or compounds substituted with one or more transition metals; lithium iron oxides such as LiFe₃O₄; lithium manganese oxides such as lithium manganese oxide represented by the chemical formula Li_{1+c1}Mn_{2c-1}O₄ (0≤c1≤0.33), LiMnO₃, LiMn₂O₃, or LiMnO₂; lithium copper oxide (Li₂CuO₂); vanadium oxides such as LiV₃O₈, V₂O₅, or Cu₂V₂O₇; nickel-site type lithium nickel oxide represented by the chemical formula LiNi_{1-c2}M_{c2}O₂ (where M is at least one selected from the group consisting of Co, Mn, Al, Cu, Fe, Mg, B, and Ga, and 0.01≤c2≤0.3); lithium manganese composite oxides represented by the chemical formula LiMn_{2-c3}M_{c3}O₂ (where M is at least one selected from the group consisting of Co, Ni, Fe, Cr, Zn, and Ta, and 0.01≤c3≤0.1) or Li₂Mn₃MOs (where M is at least one selected from the group consisting of Fe, Co, Ni, Cu, and Zn); lithium nickel cobalt manganese (NCM) composite oxide; lithium nickel cobalt manganese aluminum (NCMA) composite oxide; and LiMn₂O₄ in which a portion of Li in the chemical formula is substituted with an alkaline earth metal ion.

The negative electrode slurry may include a negative electrode active material. The negative electrode active material is not particularly limited, but compounds capable of reversible lithium intercalation and deintercalation may be used. Specific examples include carbonaceous materials such as graphite (artificial graphite, natural graphite, or graphitized carbon fibers) or amorphous carbon; metallic compounds capable of alloying with lithium such as Si, Al, Sn, Pb, Zn, Bi, In, Mg, Ga, Cd, Si alloys, Sn alloys, or Al alloys; metal oxides capable of lithium doping and dedoping, such as SiOₓ (0<x≤2), SnO₂, vanadium oxide, or lithium vanadium oxide; or composites including the above metallic compounds and carbonaceous materials, such as Si—C composites or Sn—C composites. Any one or a mixture of two or more of these may be used. Additionally, a metal lithium thin film may be used as the negative electrode active material. Carbon materials may include low-crystalline carbon and highly crystalline carbon. Examples of low-crystalline carbon include soft carbon and hard carbon. Examples of highly crystalline carbon include natural graphite or artificial graphite having amorphous, flake-like, flaky, spherical, or fibrous forms; Kish graphite; pyrolytic carbon; mesophase pitch-based carbon fiber; mesocarbon microbeads; mesophase pitches; and high-temperature calcined carbons such as petroleum or coal tar pitch derived cokes.

The battery according to an example of the present disclosure may include an electrode and a separator. The battery according to an example of the present disclosure may be a lithium secondary battery. The electrode may be the electrode according to an example of the present disclosure. The battery may include a positive electrode and a negative electrode as electrodes. In addition, the battery may include a positive electrode, a negative electrode positioned opposite to the positive electrode, and a separator located between the positive electrode and the negative electrode. Furthermore, the battery may include an electrolyte in addition to the positive electrode, the negative electrode, and the separator.

In the battery according to an example of the present disclosure, one or more selected from the group consisting of the positive electrode and the negative electrode may include the laminate 300 according to an example of the present disclosure.

In the battery according to an example of the present disclosure, if the metal film 100 is used as a current collector of the battery, it can be applied without limitation, and the laminate 300 in which the primer layer 310 is formed on at least one surface of the metal film 100 may be applied as a component of the positive electrode or the negative electrode. When it is a positive electrode, the metal film 100 may be a positive electrode current collector, and when it is a negative electrode, the metal film 100 may be a negative electrode current collector.

The positive electrode current collector is not particularly limited in type, size, or shape as long as it has conductivity without causing chemical changes in the battery. Examples of the positive electrode current collector include stainless steel, aluminum, nickel, titanium, graphitized carbon, or surface-treated materials such as aluminum or stainless steel coated with carbon, nickel, titanium, or silver. By forming fine irregularities on the surface of the positive electrode current collector, the adhesion with active material in the positive electrode slurry layer can be improved. Additionally, the positive electrode current collector can take various forms such as film, sheet, foil, net, porous body, foam, or nonwoven fabric. The current collector may have a thickness of 1 to 500 μm.

The negative electrode current collector is not particularly limited in type, size, or shape as long as it has conductivity without causing chemical changes in the battery. Examples of the negative electrode current collector include copper, stainless steel, aluminum, nickel, titanium, graphitized carbon, surface-treated copper or stainless steel coated with carbon, nickel, titanium, silver, or aluminum-cadmium alloy. By forming fine irregularities on the surface of the negative electrode current collector, the adhesion with active material in the negative electrode slurry layer can be improved. Additionally, the negative electrode current collector can take various forms such as film, sheet, foil, net, porous body, foam, or nonwoven fabric. The current collector may have a thickness of 1 to 500 μm.

The separator can separate the positive electrode and the negative electrode and provide a passage for lithium ion migration. The separator is not particularly limited as long as it is commonly used in the relevant industry. In particular, the separator preferably has low resistance to ion migration of the electrolyte and excellent wettability for the electrolyte. Specifically, porous polymer films made of polyolefin-based polymers such as ethylene polymer, propylene polymer, ethylene/butene copolymer, ethylene/hexene copolymer, and ethylene/methacrylate copolymer, or laminated structures of two or more layers thereof may be used. Also, conventional porous nonwoven fabrics, such as nonwovens made of high-melting-point glass fibers or polyethylene terephthalate fibers, may be used. Furthermore, coated separators including ceramic components or polymer materials may be used to secure heat resistance or mechanical strength, and may be used as single-layer or multi-layer structures optionally.

The electrolyte included in the battery may be an organic liquid electrolyte, an inorganic liquid electrolyte, a gel-type polymer electrolyte, a molten inorganic electrolyte, or the like commonly used in the relevant industry, but is not limited thereto. Specifically, the electrolyte may include an organic solvent and a lithium salt.

The organic solvent may be any solvent that can serve as a medium through which ions involved in the electrochemical reactions of the battery can migrate, without particular limitation. Specifically, the organic solvent may include ester-based solvents such as methyl acetate, ethyl acetate, γ-butyrolactone, and ε-caprolactone; ether-based solvents such as dibutyl ether or tetrahydrofuran; ketone-based solvents such as cyclohexanone; aromatic hydrocarbon solvents such as benzene and fluorobenzene; carbonate-based solvents such as dimethyl carbonate (DMC), diethyl carbonate (DEC), methyl ethyl carbonate (MEC), ethyl methyl carbonate (EMC), ethylene carbonate (EC), and propylene carbonate (PC); alcohol-based solvents such as ethyl alcohol and isopropyl alcohol; nitriles such as R—CN (where R is a hydrocarbon group having 2 to 20 carbon atoms in a linear, branched, or cyclic structure, which may include double bonds, aromatic rings, or ether bonds); amides such as dimethylformamide; dioxolanes such as 1,3-dioxolane; or sulfolane-based solvents. Among these, carbonate-based solvents are preferable. More preferably, a mixture of cyclic carbonates (such as ethylene carbonate or propylene carbonate), which have high ionic conductivity and high dielectric constant to enhance charge-discharge performance, and low-viscosity linear carbonate compounds (such as ethyl methyl carbonate, dimethyl carbonate, or diethyl carbonate) is used. In this case, the cyclic carbonate and linear carbonate may be mixed in a volume ratio of about 1:1 to about 1:9 to achieve excellent electrolyte performance.

The lithium salt may be any compound capable of providing lithium ions used in lithium secondary batteries, without particular limitation. Specifically, the lithium salt may include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂, among others. The concentration of the lithium salt is preferably within a range of 0.1 to 2.0 M. When the concentration of the lithium salt falls within this range, the electrolyte exhibits appropriate conductivity and viscosity, thereby demonstrating excellent electrolyte performance and enabling effective lithium ion transport.

In addition to the above electrolyte components, the electrolyte may further include one or more additives aimed at improving battery life characteristics, suppressing capacity reduction, and enhancing discharge capacity. Examples of such additives include halogenated alkylene carbonate compounds such as difluoroethylene carbonate, pyridine, triethyl phosphate, triethanolamine, cyclic ethers, ethylene diamine, n-glyme, triamide phosphate, nitrobenzene derivatives, sulfur, quinone imine dyes, N-substituted oxazolidinone, N,N-substituted imidazolidine, ethylene glycol dialkyl ethers, ammonium salts, pyrrole, 2-methoxyethanol, or aluminum trichloride. These additives may be included in an amount of 0.1 to 5% by weight based on the total weight of the electrolyte.

The battery according to one example of the present disclosure may be assembled with one or more batteries to constitute a battery module or battery pack. When the battery module or battery pack includes multiple batteries, at least some of the batteries may be electrically connected, and the connected batteries may be connected in series or in parallel.

The battery according to one example of the present disclosure may be included in power devices that provide power to portable devices such as mobile phones, laptop computers, digital cameras, or to electric vehicles.

The electric vehicle according to one example of the present disclosure may include the battery according to one example of the present disclosure.

The structural or functional descriptions of the embodiments in the present disclosure are merely illustrated to describe embodiments according to the technical idea of the present disclosure. In addition, embodiments according to the technical idea of the present disclosure may be implemented in various other forms beyond the embodiments described herein, and the technical idea of the present disclosure is not to be interpreted as being limited to the described embodiments.

### Manufacturing Example of Metal Sheet 200

The metal sheet 200 was manufactured by an electroplating method using an electrolyte 220 contained in an electrolytic bath 230, a drum 210, and an insoluble electrode plate 240, as shown in FIG. 4. The drum 210 used was a titanium drum, and the insoluble electrode plate 240 was a copper plate coated with iridium oxide on its surface.

The composition of the electrolyte 220 is as follows:
Copper: approximately 80 g/L
Sulfuric acid: approximately 120 g/L
Gelatin (weight-average molecular weight): approximately 100,000 g/mol

The drum 210 was used as the negative electrode, and the insoluble electrode plate 240 was arranged below the drum 210 as the positive electrode. These were immersed in the electrolyte 220 as shown in FIG. 4, and electricity was passed between the drum 210 and the insoluble electrode plate 240 under the following conditions to manufacture a copper foil approximately 10 μm thick:

Temperature (electrolyte temperature): approximately 50° C.
Current density: approximately 80 A/dm²
Manufacturing Example of Metal Film 100.

While conveying the metal sheet 200, which was manufactured in the example of manufacturing the metal sheet 200, through rollers, a metal film of approximately 10 μm was manufactured by using the electrolytic bath 130 containing the electrolyte 120 and the drum 110.

The drum 110 used was a titanium drum. A drum 110 with a diameter of 1 m was used, and the rotation speed was set to 30 rpm. One surface of the metal sheet 200 was brought into close contact with the drum 110 to manufacture the metal film.

The composition of the electrolyte 120 is as follows:
Copper: approximately 80 g/L
Sulfuric acid: approximately 120 g/L
Iodine: 5 mg/L

The data for the metal films manufactured above are summarized in Table 1 below. In Table 1, Rₐ₁ is the arithmetic average roughness of the surface opposite to the surface in contact with the drum 110, and Rₐ₂ is the arithmetic average roughness of the surface in contact with the drum 110. Additionally, R_{aR} is defined by Equation 1 below. In Table 1, the tensile strength was measured by preparing specimens according to the metal thin film tensile testing standard (ASTM E345) and performing tensile tests. A tensile strength of approximately 10 kg/cm² to 100 kg/cm² was evaluated as PASS, and values outside this range were evaluated as NG. In Table 1, the bending fatigue test was performed by preparing rectangular specimens of the metal film manufactured above with a width of 10 mm and a length of 10 mm, and measuring the number of bending cycles until fracture using a bending tester (bending radius: 1 mm, bending speed: 100 cpm, stroke: 20 mm) in accordance with the measurement method of JIS C 5016. A bending cycle number of 3,000 or more was evaluated as PASS, and less than 3,000 was evaluated as NG.

$${R}_{aR} = {R}_{a 1} / {R}_{a 2} \times 100 \qquad [ Equation 1 ]$$

TABLE 1

| | Arithmetic Average | | | | |
|---|---|---|---|---|---|
| | Roughness | | | Tensile Strength | Bend |
| Classification | Rₐ₁ | Rₐ₂ | R_{aR} | (kg/cm²) | Test |
| Metal film 100 | 0.56 | 0.075 | 747 | PASS | PASS |
| according to | | | | | |
| manufacturing | | | | | |
| example | | | | | |

### Example A1

In this example, the primer layer 310 was formed using a composite of SEBS (Styrene-Ethylene-Butylene-Styrene) and CNT (carbon nanotubes) among copolymers. The composition for the primer layer was prepared in a dispersion form, and toluene was used as the solvent.

The primer composition containing the copolymer was applied on both surfaces of the metal film 100 manufactured in the metal film manufacturing example, and then dried by hot air at 80° C. to form the primer layer 310, thereby manufacturing a laminate 300. The primer layer 310 was formed so as to cover the irregularities formed on the metal film 100, and the surface of the primer layer 310 had a repeating pattern of protrusions and recesses.

The primer composition was prepared such that the weight ratio of the copolymer (A), conductive material (B), and solvent (C) was 65:10:25 (A:B:C).

The copolymer used was SEBS (Styrene-Ethylene-Butylene-Styrene, G series of Kraton Corporation), and the conductive material was carbon nanotubes (CNT, MWCNT from JEIO Co., Ltd.).

A negative electrode was fabricated by applying the slurry uniformly on both surfaces of the laminate 300 manufactured as described above, drying it, and then performing a rolling process. The slurry was prepared by mixing a negative electrode active material (A), conductive material (B), styrene-butadiene rubber (SBR, C), and carboxymethyl cellulose (CMC, D) in a weight ratio of 93.5:3:1.5:2 (A:B:C:D), and sufficiently dispersing the mixture in a solvent. The negative electrode active material (A) was a mixture of artificial graphite (A1) and natural graphite (A2) at a weight ratio of 7:3 (A1:A2). The conductive material (B) was a product of Nippon Zeon Co., Ltd., and the solvent (D) was water.

A separator (SKIET Co., Ltd.) was placed between the fabricated negative electrode and the positive electrode to form a jelly roll, thereby manufacturing an electrode assembly. Lithium foil was used as the positive electrode. Then, the electrode assembly was placed inside a case, sealed, and electrolyte was injected to manufacture a mono-cell. The electrolyte injected into the case was a lithium nonaqueous electrolyte including lithium salt (LiPF6) at about 1M concentration, in which ethylene carbonate (EC) and ethyl methyl carbonate (EMC) were mixed at a volume ratio of 3:7 (EC:EMC).

### Comparative Example A1

Except that the metal film 100 manufactured in Manufacturing Example was used instead of the laminate 300 manufactured in Example A1 (i.e., the metal film 100 without the primer layer 310 was used as the current collector), the negative electrode and the mono-cell including the negative electrode were manufactured in the same manner as in Example A1.

The data for the mono-cells prepared as described above are summarized in Table 2 below.

The electrical behavior of the above mono cells was verified by each RPT (Reference performance test). In the above RPT, the capacity is the value of the discharge capacity measured at the last three discharges after repeating the charge and discharge three times under 1C-1C charge and discharge conditions. In addition, during the 1C-1C charge-discharge condition, the charge was performed under the CCCV (Constant Current Constant Voltage) protocol with 4.2V and 20 A, and the cut-off current was set to 1 A. The discharge was then performed after a resting period of 10 minutes.

During the above charge and discharge conditions, the discharge was performed at 20 A under CC (Constant Current) protocol and the cut-off voltage was set to 2.5V.

The repetition of charge and discharge is defined as one cycle or loop of the above charge condition—10 minutes of resting—the above discharge condition—10 minutes of resting.

In the above RPT, the resistance R was calculated by applying a discharge current of 20 A for 10 seconds when the SOC (State of Charge) is 50%, and then calculating R=(voltage difference at 10 second intervals)/discharge current.

In Table 2, 500 Fast Charge Cycles after Fast Charge Cycle means 500 times of charging (100 A to reach SOC 40%, 50 A to reach SOC 60%, 30 A to reach SOC 70%, and cut-off at SOC 80%), followed by 10 minutes of resting, followed by discharging (20 A under CC condition, cut-off voltage is 2.5V) and 10 minutes of resting, defined as one cycle, repeated 500 times. The capacity of the mono-cell is then expressed as a percentage of the capacity under RPT conditions.

TABLE 2

| | | | | Fast Charge |
|---|---|---|---|---|
| | RPT | | 1 C-1 C cycle | Cycle after |
| Category | Capacity | Resistance | @ 25° C. | 500 cycles |
| Example A1 | 20 Ah | 8 mohm | 2500 cycles | 95% (no plating) |
| Comparative | 20 Ah | 10 mohm | 2000 cycles | 90% (no plating) |
| Example A1 | | | | |

The present disclosure can be implemented in various modified forms, and the scope of the disclosure is not limited to the above-described examples. Therefore, if the modified examples include the components of the claims of the present disclosure, they should be regarded as falling within the scope of the present disclosure.

What is claimed is:

1. A laminate comprising:
a metal film and a primer layer on at least one surface of the metal film,
wherein the primer layer comprises a copolymer, and
wherein the copolymer comprises a first unit containing an aromatic group, a second unit being an alkylene group, and a third unit being an alkylene group different from the second unit.

2. The laminate according to claim 1, wherein a ratio (N_{C2}/N_{C3}) of the number of carbon atoms (N_{C2}) of a main chain of the second unit to the number of carbon atoms (N_{C3}) of a main chain of the third unit is 0.1 or more and 1 or less.

3. The laminate according to claim 1, wherein the aromatic group of the first unit is an aryl group.

4. The laminate according to claim 1, wherein the copolymer is a thermoplastic elastomer having a weight average molecular weight (Mw) of 10,000 to 30,000 g/mol and a polydispersity index (PDI) of 1 to 2.

5. The laminate according to claim 1, wherein the primer layer comprises the copolymer in a range of 50 to 70% by weight based on a total weight.

6. The laminate according to claim 1, wherein the metal film comprises one or more uneven portions on a surface thereof, and the primer layer is formed to surround the one or more uneven portions.

7. The laminate according to claim 1, wherein a surface of the primer layer has a pattern in which protrusions and recesses are repeated.

8. The laminate according to claim 1, wherein the primer layer further comprises a conductive material.

9. The laminate according to claim 8, wherein the conductive material comprises carbon nanotubes (CNT).

10. The laminate according to claim 1, wherein the metal film comprises a first surface and a second surface opposite to the first surface, and the first surface has greater roughness than the second surface.

11. The laminate according to claim 1, wherein the metal film comprises at least one selected from the group consisting of chlorine and iodine.

12. The laminate according to claim 11, wherein the metal film comprises chlorine, and the chlorine is comprised in a range of 1% by weight to 30% by weight based on a total weight.

13. The laminate according to claim 11, wherein the metal film comprises iodine, and the iodine is comprised in a range of 0.001% by weight to 0.1% by weight based on a total weight.

14. The laminate according to claim 10, wherein crystal grains are formed on the first surface and the second surface.

15. The laminate according to claim 1, wherein the metal film comprises copper or aluminum.

16. A method for manufacturing a laminate, comprising:
forming a primer layer on at least one surface of a metal film,
wherein the primer layer comprises a copolymer, and
wherein the copolymer comprises a first unit containing an aromatic group, a second unit being an alkylene group, and a third unit being an alkylene group different from the second unit.

17. The method for manufacturing a laminate according to claim 16, further comprising a step of manufacturing a metal film before forming the primer layer,
wherein the step of manufacturing the metal film comprises manufacturing the metal film by bringing at least a portion of a metal sheet including a first surface and a second surface opposite to the first surface into contact with a first electrolyte solution containing metal ions,
wherein the first surface of the metal sheet reacts with the first electrolyte solution, and
wherein the second surface of the metal sheet substantially does not react with the first electrolyte solution.

18. An electrode comprising the laminate according to claim 1 and an active material layer formed on at least one surface of an outermost portion of the laminate.
